(19) United States
(12) Patent Application Publication
(10) Pub. No.: US 2024/0160485 A1
(43) Pub. Date: May 16, 2024

(54) SYSTEM AND METHOD FOR RADIO ACCESS NETWORK BASEBAND WORKLOAD PARTITIONING

(71) Applicants: Altiostar Networks India Private Limited, Bangalore (IN); Altiostar Networks, Inc., Tewksbury, MA (US)

(72) Inventors: Ronak Bharatkumar LALWALA, Bangalore (IN); Raghunath HARIHARAN, Tewksbury, MA (US); Mruthyunjaya NAVALI, Tewksbury, MA (US)

(73) Assignees: Altiostar Networks India Private Limited, Bangalore (IN); Altiostar Networks, Inc., Tewksbury, MA (US)

(21) Appl. No.: 18/496,041

(22) Filed: Oct. 27, 2023

(30) Foreign Application Priority Data
Nov. 10, 2022 (IN) 202241064325

(51) Int. Cl. G06F 9/50

(52) U.S. Cl. CPC G06F 9/5033

(57) ABSTRACT

An apparatus for resource allocation of a central processing unit (CPU) including a plurality of cores includes at least one memory storing instructions, and at least one processor configured to execute the instructions to allocate a first core of the plurality of cores of the CPU to perform tasks of a first type, allocate a second core of the plurality of cores of the CPU to perform tasks of a second type that is different from the first type, assign at least one task of the first type to be performed by the first core, and transition the first core to an idle state based on the at least one task of the first type being completed.

### CROSS-REFERENCE TO RELATED APPLICATION(S)

This application is based on and claims priority to Indian Patent Application No. 202241064325, filed on Nov. 10, 2022, in the India Patent Office, the disclosure of which is incorporated herein by reference in its entirety.

### BACKGROUND

### 1. Field

Apparatuses and methods consistent with example embodiments of the present disclosure relate to resource allocation in a radio access network (RAN).

### 2. Description of Related Art

In the related art, radio access network (RAN) functions, such as distributed units (DUs), incorporate central processing unit (CPU) intensive baseband processing applications and utilize hyperthreading to enhance application performance and utilization. However, application task allocation to hyperthreads (HTs) may not be aware of idle state requirements, and thus the idle state may be entered randomly and/or non-optimally, causing utilization inefficiencies.

### SUMMARY

According to embodiments, systems and methods are provided for resource allocation of central processing units (CPU) that optimize idle state usage among hyperthreads (HTs) of cores of the CPUs.

According to an aspect of the disclosure, an apparatus for resource allocation of a central processing unit (CPU) including a plurality of cores may include at least one memory storing instructions, and at least one processor configured to execute the instructions to allocate a first core of the plurality of cores of the CPU to perform tasks of a first type, allocate a second core of the plurality of cores of the CPU to perform tasks of a second type that is different from the first type, assign at least one task of the first type to be performed by the first core, and transition the first core to an idle state based on the at least one task of the first type being completed.

According to an aspect of the disclosure, a method for resource allocation of a CPU including a plurality of cores may include allocating a first core of the plurality of cores of the CPU to perform tasks of a first type, allocating a second core of the plurality of cores of the CPU to perform tasks of a second type that is different from the first type, assigning at least one task of the first type to be performed by the first core, and transitioning the first core to an idle state based on the at least one task of the first type being completed.

According to an aspect of the disclosure, a non-transitory computer-readable storage medium may store instructions that, when executed by at least one processor, cause the at least one processor to allocate a first core of the plurality of cores of the CPU to perform tasks of a first type, allocate a second core of the plurality of cores of the CPU to perform tasks of a second type that is different from the first type, assign at least one task of the first type to be performed by the first core, and transition the first core to an idle state based on the at least one task of the first type being completed.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram showing central processing unit (CPU) allocation;

FIG. 2 is a diagram showing a pooling framework;

FIG. 3 is a diagram showing CPU allocation, according to an embodiment;

FIG. 4 is a diagram showing a pooling framework, according to an embodiment;

FIG. 5 is a diagram showing idle state timings, according to an embodiment;

FIG. 6 is a diagram showing task event distribution to CPU cores, according to an embodiment;

FIG. 7 is a flowchart of a method for resource allocation in a CPU, according to an embodiment;

FIG. 8 is a diagram of an example environment in which systems and/or methods, described herein, may be implemented; and

FIG. 9 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which a first core of a plurality of cores of a central processing unit (CPU) is allocated to perform tasks of a first type, a second core of the plurality of cores is allocated to perform tasks of a second type, a task of the first task type is assigned to be performed by the first core, and the first core is transitioned to an idle state based on the task of the first type being completed. For example, a first core of the CPU may include multiple hyperthreads (HTs) and a second core of the CPU may include multiple HTs. That is, the CPU core may correspond to a physical processor/physical core, whereas an HT may correspond to a logical processor/logical core. Each of the HTs of the first core may be configured to perform tasks of the first type (e.g., an uplink (UL) task)) and each of the HTs of the second core may be configured to perform tasks of the second type (e.g., a downlink (DL) task, a sounding reference signal (SRS) task, and/or other tasks that are different from the first type of tasks). In such configurations, for a CPU core to be transitioned to an idle state (e.g., a sleep state, a C-state, etc.), the associated HTs with the CPU core need to be in an idle state as well. That is, in a CPU core including two HTs, both HTs need to be in an idle state for the CPU core to transition to a sleep state. Accordingly, by allocating HTs from a first core to perform the tasks of the first type, allocating HTs from the second core to perform tasks of the second type, and assigning tasks accordingly, as opposed to simply assigning tasks randomly or otherwise without direction to any available HT/core, idle times between HTs may be coordinated, such that the cores may be placed in idle states more frequently and for longer periods of time, thereby reducing CPU power consumption, while also effectively and efficiently performing the assigned tasks. Such allocation may also reduce operating expenses for nodes in RANs.

Radio access network (RAN) processing may be deployed on servers built with multi-core processors utilizing multi-threading capability to parallelize the workload on cores, saving processing time and improving latency. The hyperthreading technology may enable two logical processors in a single physical processor by replacing, partitioning and sharing the resources of the core. Each of these contexts may be referred to as a logical core, and a software thread may be spawned on each of the logical cores, which the hardware runs in parallel.

In RAN baseband (BB) processing, the system may convert time-domain IQ samples received from radios to bits usable by the media access control (MAC) and vice versa. For over the air radio frequency (RF) communications, the time may be divided into transmission intervals (TTI), all having the same duration. In each TTI, data may be received from radio units, and new data may be prepared to be transmitted to the radio units. Hence, an end-to-end response time may be smaller than a period equal to the TTI duration. If the response data is not ready before the time for the transmission arrives, it may result in response failure.

BB task processing thus has a stricter demand for data transfer and processing latency, and may require real-time scheduling policies for time-critical tasks. BB task pooling frameworks may provide a task dispatching and execution system over a set of CPU resources, such that the workload is automatically balanced across multiple cores. This addresses latency bound processing of software tasks while enabling power saving optimizations. The same mechanisms may be applied to edge could applications, such as computer visions/perception employed in autonomous driving and user interfaces (e.g., augmented reality/virtual reality configurations).

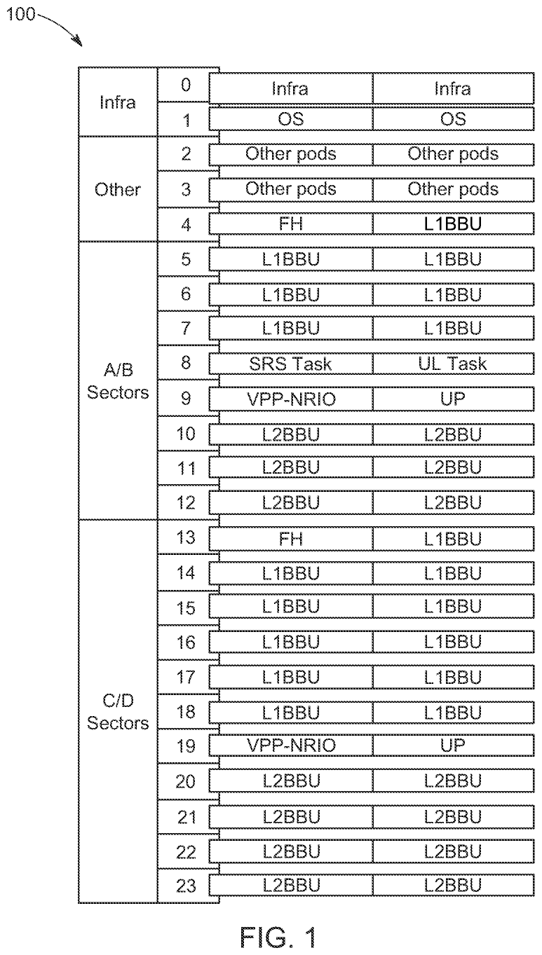

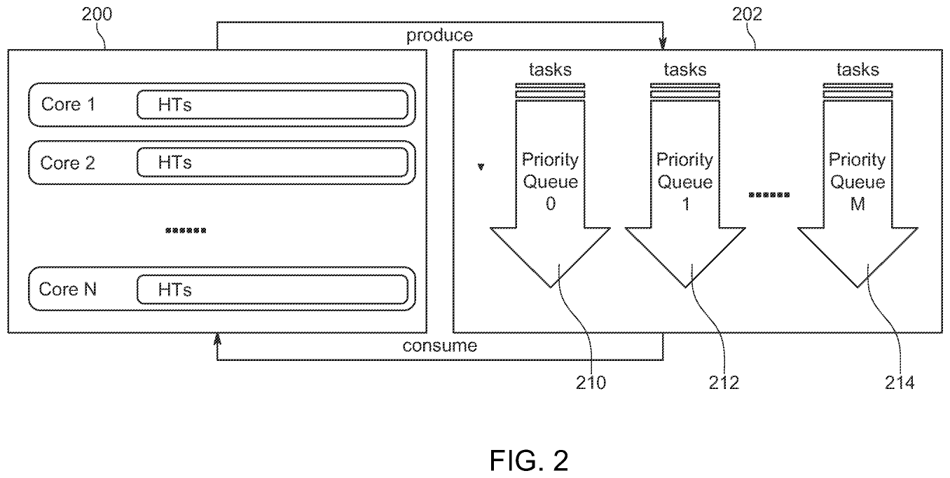

FIG. 1 is a diagram showing CPU allocation. FIG. 2 is a diagram showing a pooling framework. In a RAN, BB processing applications, such as applications that run layer 1 (L1) and layer 2 (L2) processing, may be CPU intensive (e.g., BB processing may utilize about 90% of CPU resources). In BB application implementation, processes that allocate application tasks to HTs of CPU cores may be unaware of idle state requirements for the HTs and/or CPU cores, resulting in HTs entering idle states randomly/unpredictably, such that any power saving or CPU resource saving is partial or intermittent, and may only be fully realized when HTs of a core randomly (i.e., coincidentally) enter an idle state. Accordingly, a CPU core may not be able to enter an idle C-state, even if all tasks of a type are completed.

For example, as shown in FIG. 1, the CPU 100 may include 24 physical cores (i.e., cores 0-23), and each core may include at least two HTs. For example, core 4 may include a first HT allocated for miscellaneous purposes, and an L1 BB unit (BBU) task assigned to a second HT. Core 8 may include two HTs, each assigned an L1 BBU task, core 11 may include two HTs, each assigned an L2 BBU task, etc.

As an example, the L1 BBU task may include an UL task, a DL task, or an SRS task, and these tasks may be assigned to each HT regardless of which task is assigned to a complimentary HT in the core. For example, in core 8, the first HT may be assigned an SRS task, and the second HT may be assigned an UL task.

The tasks may be assigned randomly or based on availability to each core and each HTs. As shown in FIG. 2, a plurality of cores of a CPU 200, such as Core 1, Core 2, . . . Core N, each may include a real-time (RT) thread (e.g., multiple HTs, each running a software task, such as a RT thread), and a task queue 202, including a first task 210 at priority queue 0, a second task 212 at priority queue 1, and a third task 214 at priority queue M may be implemented. As each task arrives in the queue 202, the corresponding task may be randomly assigned to a thread of a core of the CPU 200 based on available HTs or cores. As a result, in a core that includes two HTs, a first HT may complete a task and transition to an idle state, but the core itself may not transition to an idle state as the second HT may be still performing a task of a different type.

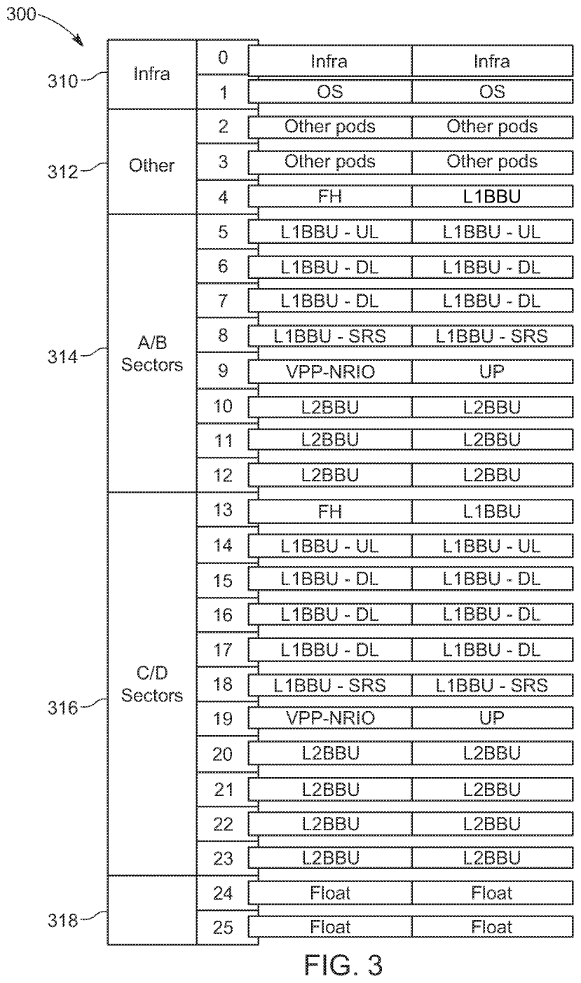

FIG. 3 is a diagram showing CPU allocation, according to an embodiment. The CPU 300 as depicted may include 24 cores (e.g., cores 0-23), and each core may include two HTs. However, other amounts of cores and HTs per core may be implemented without departing from the scope of the disclosure. The CPU 300 may include an infrastructure partition 310 for cores 0-1, which include infrastructure application tasks and operating system (OS) tasks, as well as another partition 312 for other non-BB application pods. The CPU 300 may additionally include a first sector 314 and a second sector 316, where each sector may correspond to a particular BB pod. Other sectors, partitions, application divisions, etc. may be implemented with the CPU 300 without departing from the scope of the disclosure.

Rather than assigning tasks to cores/HTs randomly or only based on priority, the system may allocate specific cores and HTs of the specific cores to perform particular types of tasks. For example, as shown in FIG. 3, core 5 and each HT of core 5 is allocated for UL type tasks, core 6 and 7, as well as their corresponding HTs, is allocated for DL type tasks, and core 8 and each HT of core 8 is allocated for SRS type tasks. Accordingly, tasks may be assigned based on core/HT allocation, along with priority.

For example, a particular application may require UL type tasks, DL type tasks, and SRS type tasks to be performed. Furthermore, the sequential time pattern of RAN L1 frame processing may allow for optimizing CPU idle times. Due to scheduling parameters (as is described by example below) and load size, the amount and duration of each type of task may vary. In some embodiments, the application may require more DL type tasks to be performed than UL type tasks and SRS type tasks, and the time slots in which the tasks are performed may be particular as well. Thus, by allocating cores/HTs to the particular types of tasks and then assigning the tasks according to the allocation, the HTs of the cores may complete their respective tasks closer in time or substantially simultaneously (i.e., the HTs may have improved task performance synchronization), allowing the core to transition to an idle state, thereby conserving resources and power consumption with respect to the core transitioned to the idle state.

As an example, in one embodiment, core 5 and the HTs of core 5 may be allocated for UL type tasks, and core 6 and the HTs of core 6 may be allocated for DL type tasks. When core 5 has completed the assigned UL type tasks, core 5 may transition to an idle state. As opposed to a scenario where the first HT of core 5 is assigned a UL type task and the second HT of core 5 is assigned a DL type task, since both HTs of core 5 are allocated to the same task type, both tasks being performed by the HTs of core 5, and core 5 is more likely to complete the tasks simultaneously or substantially simultaneously such that core 5 may transition to the idle state and remain in the idle state for a longer period of time. Furthermore, the coordinated HT pairs of the cores may be synchronized based on the task type and task scheduling (e.g., UL type tasks may only be scheduled during certain slots of a pattern, meaning that if the core is only assigned UL type tasks, when the UL type tasks are completed by the HTs, the core may transition to a sleep state for an extended duration until the next UL type tasks are configured to be scheduled during the scheduling pattern), increasing a frequency of synchronizations and thus a frequency of idle state events.

As shown in FIG. 3, the CPU 300 may also include a float sector 318 including at least one core (as shown, core 24 and 25), with each core having HTs. The cores and HTs may be designated as floating cores/floating HTs. The floating cores/floating HTs may be configured to receive a task of any type and at any timing for the purposes of handling overload or for extending various idle states. For example, an application may require an additional number of DL tasks to be performed that exceeds the available allocated DL cores, and the system may be configured to offload additional DL tasks to the floating cores/floating HTs instead of utilizing, for example, cores allocated to UL type tasks. In this way, the cores allocated to the UL type tasks may remain in an idle state while the floating cores/floating HTs are assigned the excess DL type tasks.

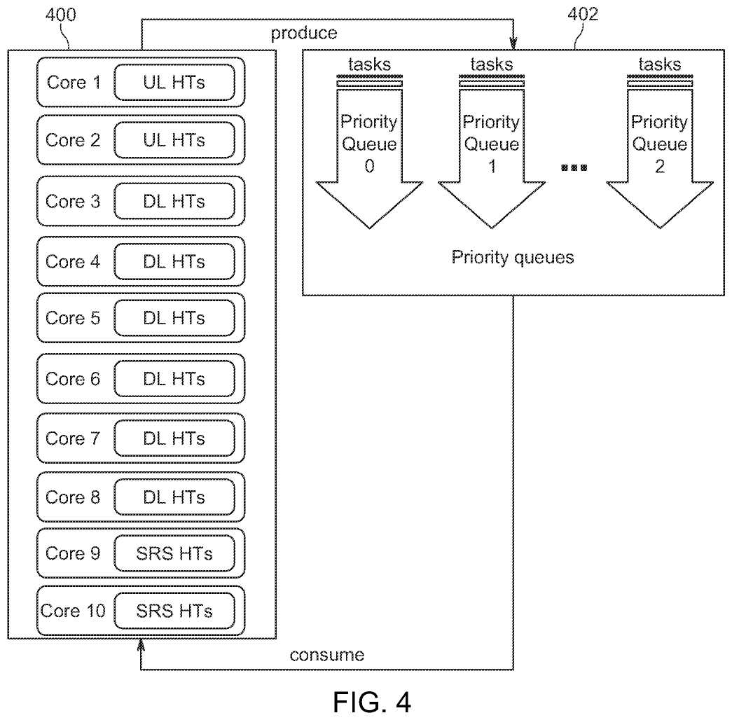

FIG. 4 is a diagram showing a pooling framework, according to an embodiment. The framework may include a CPU 400 and a priority queue 402. The CPU 400 may include a plurality of cores allocated to task types. For example, cores 1 and 2 may include HTs allocated to UL task types, cores 3-8 may include HTs allocated to DL task types, and cores 9-10 may include HTs allocated to SRS task types. The priority queue 402 may receive a plurality of tasks corresponding to various task types. As a task approaches the top of the priority queue 402, the system may determine the type of task (e.g., UL task, DL task, SRS task, etc.) and then assign the task to a corresponding core/HT configured to or allocated to process the corresponding task. In this way, task types are grouped together to corresponding cores/HTs, such that the tasks may be completed in a way that maximizes an amount of time that a core may remain in an idle state.

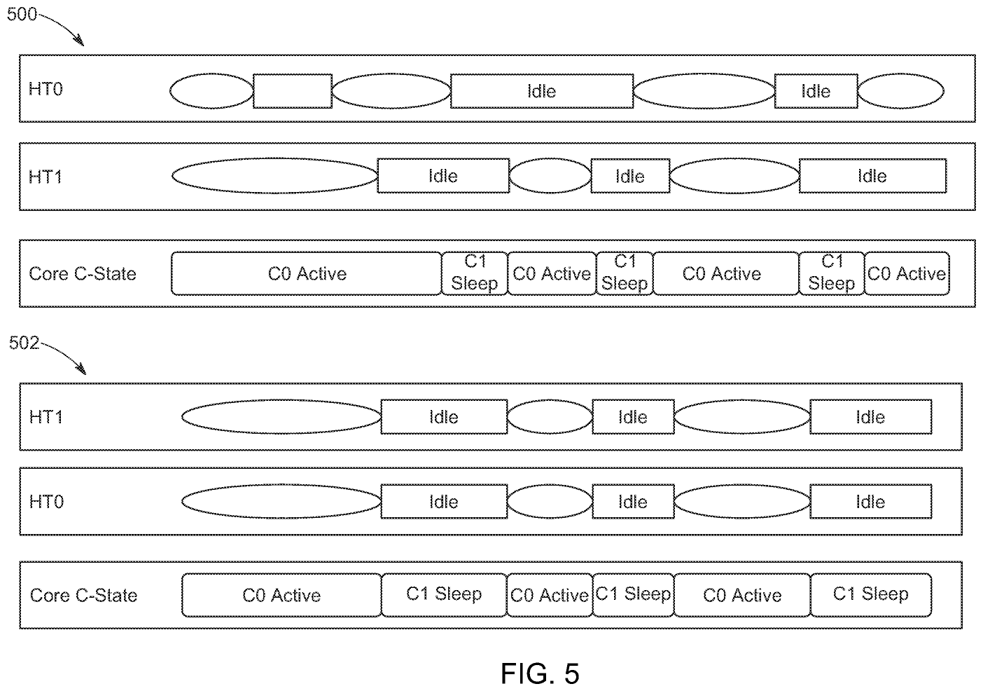

FIG. 5 is a diagram showing idle state timings, according to an embodiment. FIG. 5 shows a first graph 500 that corresponds to a scenario where a CPU core includes HT0 and HT1 that are not assigned tasks of the same type. FIG. 5 shows a second graph 502 that corresponds to a scenario where a CPU core includes HT0 and HT1 that are assigned tasks of the same type. The C0 state corresponds to an active state of the core, and the C1 state corresponds to an idle state (e.g., a sleep state) of the core. Alternative states may be implemented. For example, a C1-state may refer to a shallow sleep state (e.g., a short duration of idle time) whereas a C6-state may refer to a deep sleep state (e.g., a long duration of idle time). As shown in graph 500, in which the task types assigned to HT0 and the task types assigned to HT1 are not of the same type, tasks may be assigned randomly, only resulting in coincidental idle C1 states that are short, costing the system CPU resources and power. However, as shown in graph 502, in which the task types assigned to HT0 and the task types assigned to HT1 are of the same type, tasks may be intelligently and dynamically distributed to HTs that are allocated to the same task type, resulting in tasks being completed simultaneously, substantially simultaneously, or in better correlation than the scenario depicted in graph 500. This results in shorter C0 active states and longer C1 idle states, freeing CPU resources and conserving power consumption.

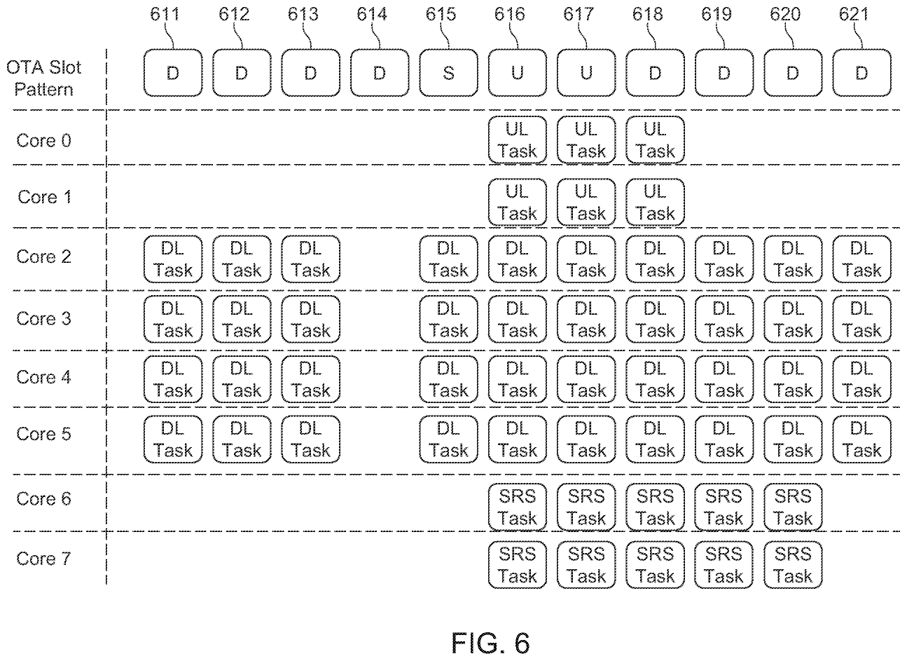

FIG. 6 is a diagram showing task event distribution to CPU cores, according to an embodiment. FIG. 6 depicts an example of a time division duplex (TDD) pattern, although the system may be implemented according to other scheduling patterns. The over-the-air (OTA) slot pattern may include 11 slots, in order of first to fourth DL slots 611-614 (denoted as “D”), a fifth switching slot 615 (denoted as “S”), sixth to seventh UL slots 616-617 (denoted as “U”) and eighth to eleventh downlink slots 618-621 (denoted as “D”). FIG. 6 also depicts tasks being assigned to various cores of a CPU as an example (as depicted, the CPU includes 8 cores, core 0-core 7, although other numbers of cores may be implemented). The HTs of cores 0-1 may be allocated to perform UL type tasks, the HTs of cores 2-5 may be allocated to perform DL type tasks, and HTs of cores 6-7 may be allocated to perform SRS tasks.

As shown in slots 611-613, DL tasks are being performed by cores 2-5, while cores 0-1 allocated to UL type tasks, as well as cores 6-7 allocated to SRS type tasks may be free during the downlink slots 611-613, such that these cores may be transitioned to an idle state to conserve power and other resources. In downlink slot 614, no tasks may be performed, as the DL type tasks may have been completed and thus cores 2-5 may be transitioned to an idle state. In the scheduling slot 615, DL type tasks may be performed by cores 2-5, while cores 0-1 allocated to UL type tasks, as well as cores 6-7 allocated to SRS type tasks may be free during slot 615, such that these cores may be transitioned to an idle state to conserve power and other resources.

As shown in uplink slots 616-617, UL type tasks may be performed by cores 0-1, DL type tasks may be performed by cores 2-5, and SRS type tasks may be performed by cores 6-7. Depending on the tasks, further processing may be required beyond the uplink slots 616-617. For example in downlink slot 618, UL type tasks may be performed by cores 0-1, as the UL type tasks may still be required to be completed as the system moves to slot 618. In slots 619-620, the UL type tasks may have been completed, such that cores 0-1 may be transitioned to an idle state, while cores 2-5 continue to perform DL type tasks and cores 6-7 continue to perform SRS type tasks. In slot 621, the SRS type tasks may have been completed, such that cores 6-7 may be transitioned to an idle state, while cores 2-5 continue to perform DL type tasks.

FIG. 6 shows an example of task event distribution according to an example TDD pattern. However, it will be understood by one of ordinary skill in the art that embodiments may be applied to various other amounts of cores, various types of tasks, and various scheduling patterns without departing from the scope of the disclosure. Furthermore, FIG. 6 is illustrative of a typical load, however load variations may occur. That is, UL and SRS task processing/assignment may require fewer or more slots than is depicted in FIG. 6. The system may be aware of when processing for UL, DL, SRS, etc., are finished and when the system should expect the next UL, DL, SRS, etc., tasks to start based on the TDD pattern. Thus, the system may utilize this information to improve sleep state scheduling as well as task type scheduling as is disclosed herein.

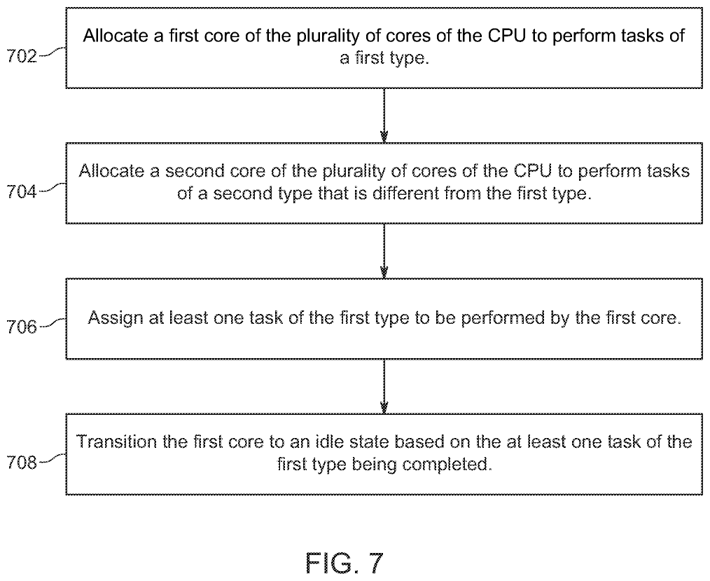

FIG. 7 is a flowchart of a method for resource allocation in a CPU, according to an embodiment. The CPU may include a plurality of cores. In operation 702, the system may allocate a first core of the plurality of cores of the CPU to perform tasks of a first type. In operation 704, the system may allocate a second core of the plurality of cores of the CPU to perform tasks of a second type that is different from the first type. In operation 706, the system may assign at least one task of the first type to be performed by the first core. In operation 708, the system may transition the first core to an idle state based on the at least one task of the first type being completed.

According to aspects of the disclosure, by allotting cores and HTs of cores to particular types of tasks, rather than randomly assigning tasks of any type to any core or HT, the system may provide coordinated completion times of tasks between HTs of a single core, providing for additional transitions to idle states of the CPU cores and/or longer durations in idle states of the CPU cores, reducing resource and power consumption.

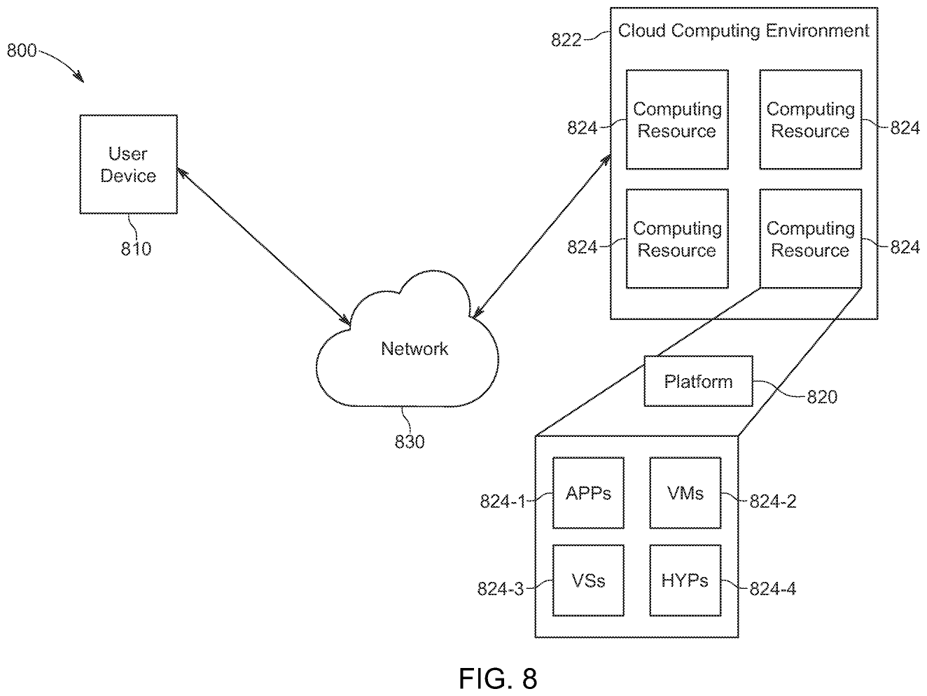

FIG. 8 is a diagram of an example environment 800 in which systems and/or methods, described herein, may be implemented. As shown in FIG. 8, environment 800 may include a user device 810, a platform 820, and a network 830. Devices of environment 800 may interconnect via wired connections, wireless connections, or a combination of wired and wireless connections. In embodiments, any of the functions and operations described with reference to FIG. 1 above may be performed by any combination of elements illustrated in FIG. 8.

User device 810 includes one or more devices capable of receiving, generating, storing, processing, and/or providing information associated with platform 820. For example, user device 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 810 may receive information from and/or transmit information to platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc. services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like.

Application 824-1 includes one or more software applications that may be provided to or accessed by user device 810. Application 824-1 may eliminate a need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”). A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems, and may manage the execution of the guest operating systems. Multiple instances of a variety of operating systems may share virtualized hardware resources.

Network 830 includes one or more wired and/or wireless networks. For example, network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

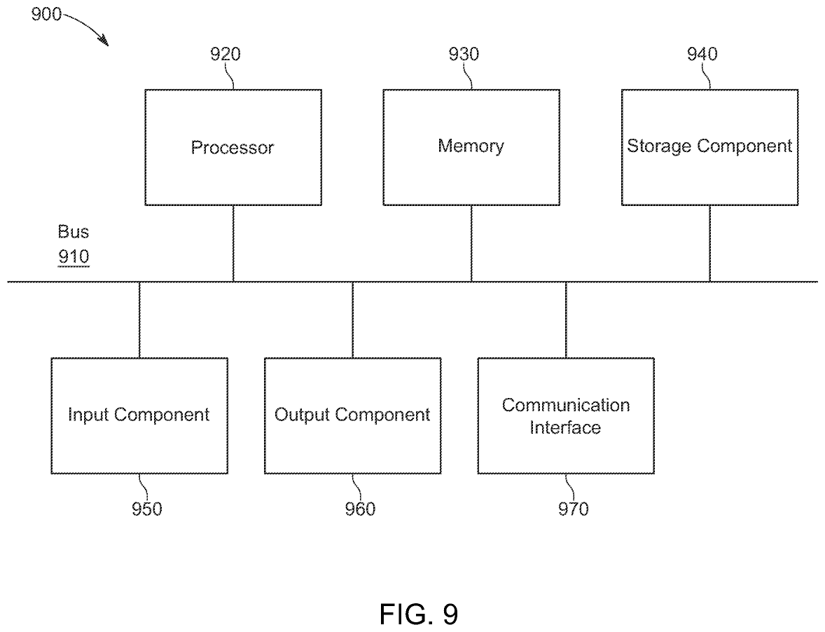

FIG. 9 is a diagram of example components of a device 900. Device 900 may correspond to user device 810 and/or platform 820. As shown in FIG. 9, device 900 may include a bus 910, a processor 920, a memory 930, a storage component 940, an input component 950, an output component 960, and a communication interface 970.

Bus 910 includes a component that permits communication among the components of device 900. Processor 920 may be implemented in hardware, firmware, or a combination of hardware and software. Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 includes one or more processors capable of being programmed to perform a function. Memory 930 includes a random access memory (RAM), a read only memory (ROM), and/or another type of dynamic or static storage device (e.g., a flash memory, a magnetic memory, and/or an optical memory) that stores information and/or instructions for use by processor 920.

Storage component 940 stores information and/or software related to the operation and use of device 900. For example, storage component 940 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 950 includes a component that permits device 900 to receive information, such as via user input (e.g., a touch screen display, a keyboard, a keypad, a mouse, a button, a switch, and/or a microphone). Additionally, or alternatively, input component 950 may include a sensor for sensing information (e.g., a global positioning system (GPS) component, an accelerometer, a gyroscope, and/or an actuator). Output component 960 includes a component that provides output information from device 900 (e.g., a display, a speaker, and/or one or more light-emitting diodes (LEDs)).

Communication interface 970 includes a transceiver-like component (e.g., a transceiver and/or a separate receiver and transmitter) that enables device 900 to communicate with other devices, such as via a wired connection, a wireless connection, or a combination of wired and wireless connections. Communication interface 970 may permit device 900 to receive information from another device and/or provide information to another device. For example, communication interface 970 may include an Ethernet interface, an optical interface, a coaxial interface, an infrared interface, a radio frequency (RF) interface, a universal serial bus (USB) interface, a Wi-Fi interface, a cellular network interface, or the like.

Device 900 may perform one or more processes described herein. Device 900 may perform these processes in response to processor 920 executing software instructions stored by a non-transitory computer-readable medium, such as memory 930 and/or storage component 940. A computer-readable medium is defined herein as a non-transitory memory device. A memory device includes memory space within a single physical storage device or memory space spread across multiple physical storage devices.

Software instructions may be read into memory 930 and/or storage component 940 from another computer-readable medium or from another device via communication interface 970. When executed, software instructions stored in memory 930 and/or storage component 940 may cause processor 920 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

In embodiments, any one of the operations or processes of FIGS. 1-7 may be implemented by or using any one of the elements illustrated in FIGS. 8 and 9.

According to embodiments, an apparatus for resource allocation of a CPU including a plurality of cores may include at least one memory storing instructions, and at least one processor configured to execute the instructions to allocate a first core of the plurality of cores of the CPU to perform tasks of a first type, allocate a second core of the plurality of cores of the CPU to perform tasks of a second type that is different from the first type, assign at least one task of the first type to be performed by the first core, and transition the first core to an idle state based on the at least one task of the first type being completed.

The at least one processor may be further configured to execute the instructions to assign at least one task of the second type to be performed by the second core.

The at least one processor may be configured to execute the instructions to transition the first core to an idle state based on the at least one task of the first type being completed and while the at least one task of the second type is being performed by the second core.

The tasks of the first type may include uplink tasks and the tasks of the second type may include either downlink tasks or SRS tasks.

The tasks of the first type may include downlink tasks and the tasks of the second type may include either uplink tasks or SRS tasks.

The tasks of the first type may include SRS tasks and the tasks of the second type may include either uplink tasks or downlink tasks.

The at least one processor may be configured to execute the instructions to assign the at least one task of the first type to be performed by the first core by assigning a first task of the first type to be performed by a first HT of the first core and assigning a second task of the first type to be performed by a second HT of the first core.

The at least one processor may be configured to transition the first core to an idle state when both the first task of the first type is completed by the first HT of the first core and the second task of the first type is completed by the second HT of the first core.

The at least one processor may be further configured to execute the instructions to assign a first task of the second type to be performed by a first HT of the second core and assign a second task of the second type to be performed by a second HT of the second core.

The at least one processor may be further configured to execute the instructions to allocate a third core of the plurality of cores of the CPU to perform tasks of a third type that is different from both the first type and the second type, assign a first task of the third type to be performed by a first HT of the third core, and assign a second task of the third type to be performed by a second HT of the third core.

The tasks of the first type may include uplink tasks, the tasks of the second type may include downlink tasks, and the tasks of the third type may include SRS tasks.

According to embodiments, a method for resource allocation of a CPU including a plurality of cores may include allocating a first core of the plurality of cores of the CPU to perform tasks of a first type, allocating a second core of the plurality of cores of the CPU to perform tasks of a second type that is different from the first type, assigning at least one task of the first type to be performed by the first core, and transitioning the first core to an idle state based on the at least one task of the first type being completed.

The method may include assigning at least one task of the second type to be performed by the second core.

The transitioning the first core to an idle state may be performed based on the at least one task of the first type being completed and while the at least one task of the second type is being performed by the second core.

The tasks of the first type may include uplink tasks and the tasks of the second type may include either downlink tasks or SRS tasks.

Assigning the at least one task of the first type to be performed by the first core may include assigning a first task of the first type to be performed by a first HT of the first core and assigning a second task of the first type to be performed by a second HT of the first core.

Transitioning the first core to an idle state may be performed when both the first task of the first type is completed by the first HT of the first core and the second task of the first type is completed by the second HT of the first core.

The method may include assigning a first task of the second type to be performed by a first HT of the second core and assigning a second task of the second type to be performed by a second HT of the second core.

The method may include allocating a third core of the plurality of cores of the CPU to perform tasks of a third type that is different from both the first type and the second type, assigning a first task of the third type to be performed by a first HT of the third core, and where the tasks of the first type may include uplink tasks, the tasks of the second type may include downlink tasks, and the tasks of the third type may include SRS tasks.

According to embodiments, a non-transitory computer-readable storage medium may store instructions that, when executed by at least one processor, cause the at least one processor to allocate a first core of the plurality of cores of the CPU to perform tasks of a first type, allocate a second core of the plurality of cores of the CPU to perform tasks of a second type that is different from the first type, assign at least one task of the first type to be performed by the first core, and transition the first core to an idle state based on the at least one task of the first type being completed.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. An apparatus for resource allocation of a central processing unit (CPU) comprising a plurality of cores, the apparatus comprising:
at least one memory storing instructions; and
at least one processor configured to execute the instructions to:
allocate a first core of the plurality of cores of the CPU to perform tasks of a first type;
allocate a second core of the plurality of cores of the CPU to perform tasks of a second type that is different from the first type;
assign at least one task of the first type to be performed by the first core; and
transition the first core to an idle state based on the at least one task of the first type being completed.

2. The apparatus of claim 1, wherein the at least one processor is further configured to execute the instructions to:
assign at least one task of the second type to be performed by the second core.

3. The apparatus of claim 2, wherein the at least one processor is configured to execute the instructions to transition the first core to an idle state based on the at least one task of the first type being completed and while the at least one task of the second type is being performed by the second core.

4. The apparatus of claim 2, wherein the tasks of the first type comprise uplink tasks, and
wherein the tasks of the second type comprise either downlink tasks or sounding reference signal (SRS) tasks.

5. The apparatus of claim 2, wherein the tasks of the first type comprise downlink tasks, and
wherein the tasks of the second type comprise either uplink tasks or sounding reference signal (SRS) tasks.

6. The apparatus of claim 2, wherein the tasks of the first type comprise sounding reference signal (SRS) tasks, and
wherein the tasks of the second type comprise either uplink tasks or downlink tasks.

7. The apparatus of claim 1, wherein the at least one processor is configured to execute the instructions to assign the at least one task of the first type to be performed by the first core by:
assigning a first task of the first type to be performed by a first hyperthread (HT) of the first core; and
assigning a second task of the first type to be performed by a second HT of the first core.

8. The apparatus of claim 7, wherein the at least one processor is configured to transition the first core to an idle state when both the first task of the first type is completed by the first HT of the first core and the second task of the first type is completed by the second HT of the first core.

9. The apparatus of claim 7, wherein the at least one processor is further configured to execute the instructions to:
assign a first task of the second type to be performed by a first HT of the second core; and
assign a second task of the second type to be performed by a second HT of the second core.

10. The apparatus of claim 9, wherein the at least one processor is further configured to execute the instructions to:
allocate a third core of the plurality of cores of the CPU to perform tasks of a third type that is different from both the first type and the second type;
assign a first task of the third type to be performed by a first HT of the third core; and
assign a second task of the third type to be performed by a second HT of the third core.

11. The apparatus of claim 10, wherein the tasks of the first type comprise uplink tasks, the tasks of the second type comprise downlink tasks, and the tasks of the third type comprise sounding reference signal (SRS) tasks.

12. A method for resource allocation of a central processing unit (CPU) comprising a plurality of cores, the method comprising:
allocating a first core of the plurality of cores of the CPU to perform tasks of a first type;
allocating a second core of the plurality of cores of the CPU to perform tasks of a second type that is different from the first type;
assigning at least one task of the first type to be performed by the first core; and
transitioning the first core to an idle state based on the at least one task of the first type being completed.

13. The method of claim 12, further comprising assigning at least one task of the second type to be performed by the second core.

14. The method of claim 13, wherein transitioning the first core to an idle state is performed based on the at least one task of the first type being completed and while the at least one task of the second type is being performed by the second core.

15. The method of claim 13, wherein the tasks of the first type comprise uplink tasks, and
wherein the tasks of the second type comprise either downlink tasks or sounding reference signal (SRS) tasks.

16. The method of claim 12, wherein assigning the at least one task of the first type to be performed by the first core comprises:
assigning a first task of the first type to be performed by a first hyperthread (HT) of the first core; and
assigning a second task of the first type to be performed by a second HT of the first core.

17. The method of claim 16, wherein transitioning the first core to an idle state is performed when both the first task of the first type is completed by the first HT of the first core and the second task of the first type is completed by the second HT of the first core.

18. The method of claim 16, further comprising:
assigning a first task of the second type to be performed by a first HT of the second core; and
assigning a second task of the second type to be performed by a second HT of the second core.

19. The method of claim 18, further comprising:
allocating a third core of the plurality of cores of the CPU to perform tasks of a third type that is different from both the first type and the second type;
assigning a first task of the third type to be performed by a first HT of the third core; and
assigning a second task of the third type to be performed by a second HT of the third core,
wherein the tasks of the first type comprise uplink tasks, the tasks of the second type comprise downlink tasks, and the tasks of the third type comprise sounding reference signal (SRS) tasks.

20. A non-transitory computer-readable storage medium storing instructions that, when executed by at least one processor, cause the at least one processor to:
allocate a first core of a plurality of cores of a central processing unit (CPU) to perform tasks of a first type;
allocate a second core of the plurality of cores of the CPU to perform tasks of a second type that is different from the first type;
assign at least one task of the first type to be performed by the first core; and
transition the first core to an idle state based on the at least one task of the first type being completed.
